(19) United States
(12) Patent Application Publication
(10) Pub. No.: US 2016/0203593 A1
(43) Pub. Date: Jul. 14, 2016

(54) METHOD AND DEVICE FOR TESTING AN INSPECTION SYSTEM FOR DETECTING SURFACE DEFECTS

(71) Applicant: THYSSENKRUPP STEEL EUROPE AG, Duisburg (DE)

(72) Inventors: Harald HENKEMEYER, Moers (DE); Wolf MIßMAHL, Willich (DE)

(73) Assignee: THYSSENKRUPP STEEL EUROPE AG, Duisburg (DE)

(21) Appl. No.: 14/916,536

(22) PCT Filed: Aug. 28, 2014
(86) PCT No.: PCT/EP2014/068306

§ 371 Date: Mar. 3, 2016

(30) Foreign Application Priority Data
Sep. 10, 2013 (DE) 10 2013 109 915.7

(51) Int. Cl. G06T 7/00; G06K 9/62; G01N 21/93

(52) U.S. Cl. CPC G06T 7/0004; G01N 21/93; G06K 9/6267; G06K 9/6262; G06T 2207/30136

(57) ABSTRACT

Systems and methods that check inspection systems for proper detection of surface defects without impairing production processes are needed. In many cases, the disclosed systems and methods concern detection of surface defects in flat steel products. One example method involves generating a photograph of a surface of a product with a camera, transmitting the photograph in digital form to an image processing device, integrating a digitized representation of a surface defect into the digitized photograph, performing fault detection in the image processing device based on the photograph and the digitized representation of the surface defect, and determining whether the image processing device properly detected the digitized representation of the surface defect as a fault of the surface of the product.

The invention relates to a method for checking an inspection system for the detection of surface defects of a product, preferably flat steel products. Furthermore, the invention relates to an inspection system that can be checked by such a method, having at least one camera, preferably a digital camera, for producing at least one photograph of at least one surface of at least one product, and having a digitizing unit for digitizing the photograph.

During the manufacture of products in which special quality requirements are placed on the surface, on request quality assurance is carried out, it is done so by the quality of the surface of the product being checked by an inspection system. If non-tolerable errors are determined during this testing, the product can be separated out. Appropriate products are, for example, metal products such as flat steel or flat light metal products. In this case, flat products are understood to be all rolled products present as strip, sheet, blank or plate in the hot-rolled or cold-rolled state. In particular, coated or uncoated steel strips come into consideration.

Steel strips are produced with great lengths and at high speeds, the finished steel strip being wound up to form a coil. If the surface quality of steel strips or comparable products is to be measured in line and non-destructively, the quality testing of the surface must be carried out very quickly and reliably.

In order to permit automated and non-destructive quality testing, methods and inspection systems are known in which at least one camera produces photographs of the surface of the product and passes said photographs on in digitized form to an image processing device. The latter then checks the photographs for surface defects and classifies these with regard to the type of surface defects. By using the number and type of surface defects on a specific section of the surface of the product, a decision can be made automatically as to whether said area meets the quality stipulations or, if necessary, the corresponding area of the product or the entire product must be discarded.

In order that the automated quality assurance supplies satisfactory results, various digitized photographs of faulty product surfaces are fed to the inspection system in a preliminary training phase. During this training phase, the inspection system is calibrated with regard to fault detection and fault classification. Following satisfactory training and completed calibration, the inspection system can be used for quality assurance. However, in operation it is necessary to check at regular intervals whether the inspection system continues to operate satisfactorily or whether adaptation or renewed calibration is necessary. In this way, it is intended to prevent relevant surface defects from remaining undetected or non-relevant surface defects from inadvertently being classified as relevant surface defects.

In order to check the functioning of an inspection system, various methods are known. In some methods, the surface to be inspected is deliberately provided with surface defects at regular time intervals, a check being made as to whether these surface defects are detected as faults by the inspection system. In order to avoid the surface to be inspected having to be damaged for the checking of the inspection system, in other methods images of surface defects are stuck to the surface to be inspected at regular time intervals. An examination is then made as to whether the surface defects are detected. Although the surface to be inspected is not damaged, because the images stuck on can be pulled off the inspected surface again, as a rule the manufacturing process for the product must be interrupted in order to stick an image of a surface defect onto the surface to be inspected. This is the case in particular during the manufacture of very fast moving metal strips, since the metal strips have too high a feed speed to stick images of surface defects onto the surface of the moving metal strip. In order that the manufacturing process does not have to be interrupted, a known method for checking an inspection system is based on feeding in a digitized image of a previously recorded test surface instead of a digitized image photographed by the at least one camera, and having said digitized image evaluated by the image processing device. By using the evaluation result, it is possible to check whether the fault detection and fault classification is carried out satisfactorily.

In the last-named method, however, there is the disadvantage that the image processing device, while it is examining the reference image of a reference surface, cannot examine the real surface of the product for faults. Surface defects can therefore remain undetected. In addition, it has been shown in practice that a calibration carried out by using the reference images does not always lead to satisfactory accuracies of the inspection system.

Therefore, the present invention is based on the object of configuring and developing a method for checking an inspection system for the detection of surface defects of a product and an inspection system that can be checked, in each case of the type mentioned at the beginning and previously described in more detail, in such a way that quality assurance with very high quality can be achieved without noticeably impairing the production process of the product having the surface to be inspected.

This object is achieved in a method according to claim 1, in which at least one camera, preferably a digital camera, produces at least one photograph of a surface of at least one product, in which the at least one photograph is passed on in digitized form to an image processing device, in which at least one digitized representation of a surface defect is integrated into the digitized photograph, in which the image processing device carries out fault detection by using the digitized photograph, including the digitized representation of a surface defect, and in which it is determined whether the image processing device detects the digitized representation of a surface defect as a fault of the inspected surface.

The aforementioned object is additionally achieved in an inspection system according to the preamble of claim 13 in that an integration unit for integrating a digitized representation of a surface defect into the digitized photograph is provided, in that an image processing device is provided for fault detection by using the digitized photograph, including the digitized representation of a surface defect, and in that a determination unit is provided for determining whether the digitized representation of a surface defect is detected by the image processing device as a fault of the inspected surface.

The invention is therefore based on the situation in which, firstly, by means of a camera, a photograph of a surface to be inspected of a product is produced and said photograph is then passed on in digitized form to an image processing device, wherein a digitized representation of a surface defect in the sense of a test defect or reference defect is integrated into the photograph, therefore, so to speak, inserted. The image processing device treats the corresponding image as though it were a digitized image of the surface to be examined, that is to say as though the surface would also have the corresponding surface defect physically or really. Thus, it is then possible to check whether the image processing device also detects the surface defect as such. Here, the surface defect is preferably chosen such that it should be detected by the image processing device as a surface defect. However, it is also possible to choose a surface defect which should not be detected, in order to check whether the surface defect actually remains undetected.

This procedure makes it unnecessary for the manufacturing process of the product to be interrupted, specifically also not during the manufacture of steel strips moving very quickly past the camera. Furthermore, the quality assurance can be carried out in a manner virtually unaffected by the checking of the inspection system. Since only very locally limited digitized representations of comparatively small surface defects have to be integrated into the actual photographs of surfaces to be inspected, the remaining parts of the images of the actual surfaces to be inspected can be examined for faults by the image processing device independently of the checking of the inspection system. In addition, taking the actual surfaces into account during the checking of the inspection system, wherein the representations of surface defects are inserted into photographs actually taken of inspected surfaces, instead of replacing actual images by reference images of test surfaces, leads to its being possible for subsequent calibration to be carried out very much more reliably and in a manner matched to the actual surfaces.

Because of the above advantages of the invention, it is additionally economically possible to check the inspection system at very short time intervals, if required quasi-continuously, in order to be able to detect immediately when adaptations are required. The checking at very short time intervals additionally permits an adequate database to be obtained for very meaningful statistical evaluation.

Alternatively or additionally, it is possible to use digitized representations of different surface defects simultaneously and/or one after another for the checking of the inspection system. Thus, it is possible to obtain a differentiated statement about the quality of the quality assurance which, for example, depends on the nature and/or intensity of the surface defects. The intensity can be determined, for example, by the height or depth of the defect and by its size and/or extent.

In principle, any type of camera can be considered as at least one camera. Preferably, however, it will be a digital camera, since this produces digitized images directly and a separate step for converting the photograph into a digitized image can be omitted. The digitization unit is then already integrated into the camera. In addition, it is also possible for a plurality of cameras to be provided in order to produce an image of the surface to be inspected with satisfactory quality. Here, the image from a camera or a plurality of cameras can be provided with at least one digitized representation of a surface defect and examined in parallel or one after another. However, it is also possible to provide for a single digitized image to be produced first from a plurality of photographs, for example by superimposing the photographs, into which single image a digitized representation of a surface defect is then integrated.

In principle, it is quite possible for the digitized representation of a surface defect to be integrated into the digitized photograph of the surface to be inspected with the aid of the integration unit by the digitized representation of the surface defect being superimposed on the digitized photograph of the real surface at one location. However, it will preferably be such that the digitized representation of the surface defect replaces the digitized photograph of the actual surface in the region of the representation. Expressed another way, the pixels of the representation of the surface defect can replace the pixels of the image of the surface to be inspected at an appropriate point in the image of the real surface.

Depending on the dimensions of the product or, in the event of parallel quality assurance of the plurality of products, it is also possible in the inspection system and the corresponding checking method to provide a plurality of cameras which produce photographs of different surfaces, different products and/or different sections of a surface. These photographs can if necessary be examined for surface defects in parallel by an image processing device or by a plurality of image processing devices.

With regard to the at least one camera, it is of course preferred if this both produces the photograph into which a digitized representation of a real and/or synthetic surface defect is integrated, and also produces the photographs which are otherwise fed (un-manipulated) to the image processing device for fault finding during continuous quality assurance. Therefore, no separate camera for producing the photographs to be manipulated with the aid of digitized representations of surface defects is provided or required for checking the inspection system.

The digital representation of the at least one surface defect does not have to be an image of a real surface defect. It can also be an artificially produced, that is to say for example programmed, surface defect. This surface defect does not have to simulate a real conceivable surface defect either. If required, the surface defect can be constructed without taking real surface defects into account. Nevertheless, for the sake of understanding, hereinafter such a case will also be mentioned as a surface defect, since this in any case will be distinguished from an optimal product surface. In addition, the integration of the digitized representation of the surface defect into the digitized photograph produced by the camera leads to an artificial photograph which differs from the real image.

Otherwise, neither the method nor the inspection system is restricted to the digitized representation of the surface defect representing only the surface defect. It will if necessary be such that the corresponding one represents one from a non-defective surface section. In this way, in the photograph fed to the image processing device, a reproducible transition between flawless surface and defect will be achieved. However, this transition can also be omitted to the benefit of the transition from the real surface to the defect in the digitized representation of the surface defect.

In addition, the digitized representation of the surface defect is preferably integrated only into a relatively small section of the photograph produced by the camera, in order to affect the continuous quality assurance as little as possible.

In principle, it is further preferred for the method described for checking the inspection system to be carried out automatically and for a manual intervention to be made only when a manual calibration, non-automated adaptation or the like is required.

In the following text, preferred embodiments of the method and of the apparatus for carrying out the method will be described jointly without in any case distinguishing explicitly between the apparatus and the method. However, the person skilled in the art will see the preferred apparatus features and method features by using the context.

In a first preferred embodiment of the method and of the apparatus, provision is made for the faults detected by the image processing device to be classified by means of a classification device. This classification can be carried out by using predefined parameters relating to the surface defects. The surface defects detected can be classified by their nature, for example, and thus divided up into scratches, dents, elevations, surface cracks, oxidations, contaminants and/or foreign bodies. Alternatively or additionally, the surface defects detected can also be classified by their intensity, which can be determined by the height, depth, size and/or extent. It is also possible, for example, to distinguish whether this involves a slight, moderate or serious surface defect, for example in the sense of a slight, moderate or deep scratch. For the case in which a classification of the surface defects is carried out, it is preferred if it is determined whether the classification device classifies the fault detected as stipulated by using the digitized representation of a surface defect. In this way, the calibration can be improved and the quality of the quality assurance can be assessed better. The checking of the classification can be carried out additionally or alternatively to the determination as to whether the surface defect integrated into the photograph of the surface to be inspected is detected or not. If a check is made as to whether the classification has been carried out correctly, this specifically permits conclusions to be drawn as to whether the surface defect has been detected as such at all or not.

In order that it is possible to assess whether the at least one fault that can be traced back to at least one digitized representation of a surface defect has been detected and/or whether the fault has been classified as stipulated, it is recommended that this be displayed, signaled and/or stored. The display can be made immediately or upon request, while the signaling can be carried out optically and/or acoustically. The storage of the corresponding information has the advantage that computer-aided evaluation and/or time-offset evaluation can be carried out.

By means of a suitable choice of the digitized representation of a surface defect or the digitized representation of different surface defects, on the basis of the finding as to whether the surface defects are detected and/or classified correctly, a determination is possible as to whether predefined tolerance criteria of the inspection system have been exceeded. Slight deviations from the stipulations for the detection of faults can be tolerated regularly. The response is different if the deviations become too large and thus a tolerance criterion is exceeded. The exceeding of a tolerance criterion can additionally be indicated, signaled and/or stored as necessary. In this way, a supervisor is given feedback about the exceeding of a tolerance range and can intervene appropriately.

Alternately or additionally, if necessary by using the detected and/or non-detected faults that can be traced back to at least one digitized representation of at least one surface defect, it is possible to determine at least one performance index which characterizes the quality of the inspection system for the detection of surface defects. In this way, the quality of the inspection system can be quantified better. Alternatively or additionally, at least one performance index can be determined by using the classification of the at least one fault that can be traced back to a digitized representation of at least one surface defect as stipulated or deviating from the stipulations. The algorithm by which the performance index is determined can largely be chosen freely or adapted to the intended use.

If necessary, provision can be made in terms of method and apparatus for the image processing device and/or the classification device to be calibrated when a digitized representation of a surface defect or a plurality of digitized representations of at least one surface defect is/are not detected as a fault and/or is/are not classified as stipulated. This ensures that the inspection system always permits quality assurance with adequate quality. Here, the calibration can be carried out manually. If it is possible, however, it is preferred to carry out the calibration automatically, specifically by using the data which have been obtained previously through the checking of the inspection system. Alternatively or additionally to a calibration of the inspection system, the data obtained by the checking of the inspection system can be used for the purpose of an audit about the quality control of the quality assurance.

In order that the quality assurance of the product to be inspected remains as unaffected as possible by the checking of the inspection system, the faults detected by the image processing device on the basis of real surface defects of the inspected surface can be stored as such and the faults detected by the image processing device on the basis of at least one digitized representation of a surface defect can not be stored or can be stored differently, for example at another location, from the faults that can be traced back to real surface defects. By means of the different handling of the faults detected according to whether they originate from the actual photograph of the surface or from the introduced digitized representation of a surface defect, both types of fault can be distinguished. This can expediently be used in that, during the further processing of the product, locations with real faults are cut out and discarded, while the faults detected on the basis of the digitized representation of surface defects, that is to say the faults that do not really exist, do not lead to part of the product being cut out and/or discarded. If part of the product cannot readily be cut out, as is the case for example in a steel strip, in the event of a real fault the entire product can be discarded, for example in the form of a plate.

It is particularly expedient if the faults detected by the image processing device on the basis of a digitized representation of a surface defect are stored in such a way that they can be distinguished automatically from faults that can be traced back to real surface defects. It is then automatically possible to draw distinctions according to the nature of the fault. The corresponding data can therefore be used both for the calibration and also for the decision about the further use of the product.

Alternatively or additionally, the faults detected on the basis of real surface defects can be stored together with at least one associated item of classification information. In this way, it is more easily possible to decide whether the fault detected justifies rejection of the product or part thereof.

If the faults detected on the basis of real surface defects are stored so as to be linked with an item of location information characterizing the location of the real surface defect on the inspected surface, the region covering the location of the surface defect can be removed or discarded simply and reliably, if necessary automatically. In the case of a steel sheet, this can also be carried out only when the steel strip is unwound from the coil again for further use. Here, it is particularly preferable if this information is stored together with at least one item of classification information. It is then simply possible to determine whether the surface defect at the corresponding location requires intervention or can be tolerated.

In order to check whether a specific surface defect is detected by the inspection system or which surface defects are detected as faults by the inspection system, the digitized representation of a surface defect that is used can be, for example, a synthetically produced representation. This can represent, for example, a specific contrast variation. The synthetically produced representation of a surface defect does not therefore have to appear similar to a surface defect which could really occur. In this way, if appropriate, the quality of the fault detection by the inspection system can be determined more precisely and/or at least one particularly expedient surface defect can be “tailor-made” for the checking of the inspection system.

Alternatively or additionally, the digitized representation of a surface defect that is used can be at least one digitized representation of a real surface defect, for example in the form of a scratch, a dent, an elevation, a surface crack, an oxidation, an oxidic slag inclusion, a contaminant and/or a foreign body. In this way, if appropriate, the quality of the fault classification by the inspection system can be determined more precisely.

The invention will be explained in more detail below by using a drawing merely representing one exemplary embodiment. In the drawing

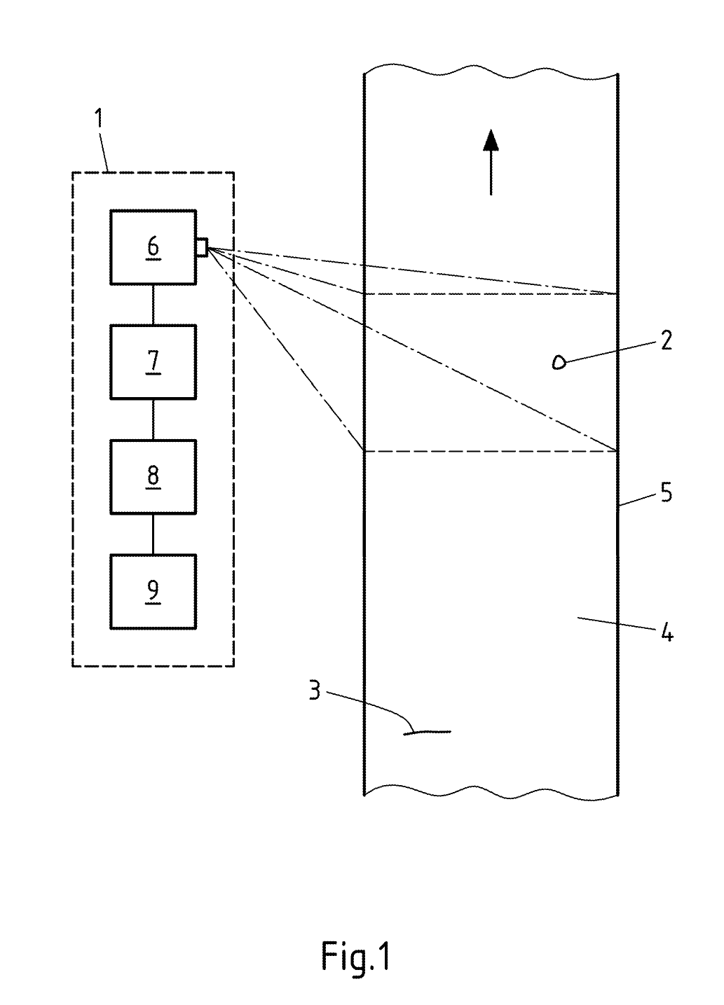

FIG. 1 shows an inspection system according to the invention for the detection of surface defects in a schematic illustration,

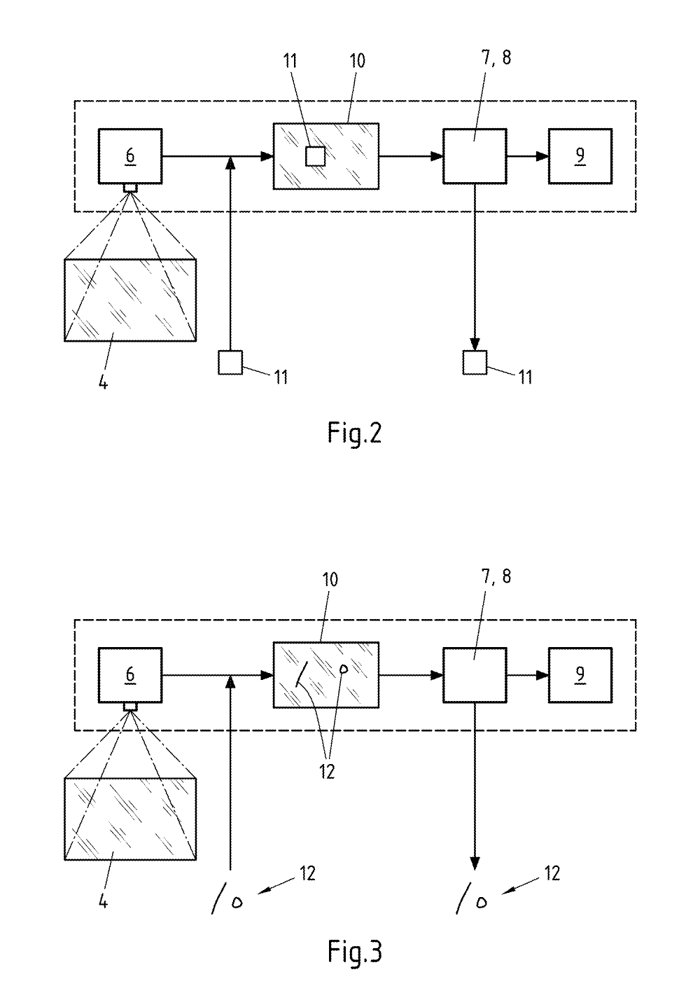

FIG. 2 shows method steps of the method according to the invention in a schematic illustration, and

FIG. 3 shows further method steps of the method according to FIG. 2 in a schematic illustration.

FIG. 1 illustrates an inspection system 1 which is intended to detect surface defects 2, 3 on a surface 4 of a product 5 in the form of a flat steel product. To this end, the inspection system 1 comprises a camera 6, past which the surface 4 to be inspected of the product 5 is led in the production direction indicated by the arrow. In the inspection system 1 illustrated and to this extent preferred, the camera 6 detects the surface 4 of the product 5 over the entire width of the latter. The camera 6 is a digital camera, which produces a digitized photograph of the surface 4 directly.

The digitized photograph produced by the camera 6 is passed on to an image processing device 7, which checks the photograph for possible surface defects 2, 3, which are detected by the image processing device 7 as faults on the surface 4 when said faults are delimited adequately from fault-free regions of the surface 4, for example with regard to the contrast in the photograph. Contained in the photograph illustrated in FIG. 1 is a dent, which is intended to be detected by the image processing device 7 if the image processing device 7 is set up correctly, in particular calibrated. A scratch is present at another location on the surface 4.

The information relating to a fault detected by the image processing device 7 is passed on to a classification device 8, which classifies the faults in accordance with predefined criteria. For example, a subdivision can be carried out as to whether the fault is a scratch, a dent, an elevation, a surface crack, an oxidation, an oxidic slag inclusion, a contaminant and/or a foreign body. Alternatively or additionally, a classification can be carried out as to how critical the respective fault is for the further use of the product 5.

The information relating to the respective fault and the respective classification of the fault is stored in a memory 9 together with location information about where the fault on the surface 4 has surfaced. The stored information can be fed together with the product 5 to the further use of the product 5, so that the faults can be taken into account during said further use. Surface sections having non-tolerable faults can, for example, be discarded.

FIG. 2 illustrates how the inspection system according to FIG. 1 is checked automatically at regular intervals. It shows schematically how a section of a surface 4 of a product is photographed by the camera, which produces a digitized photograph 10 of the surface 4. A digitized representation 11 of a synthetic surface defect is integrated into said digitized photograph 10 by means of an integration unit, not illustrated. The digitized representation 11 occupies a very small region of the resultant photograph 10. In FIG. 2 the digitized representation 11 of the surface defect is illustrated highly enlarged relative to the photograph 10 so that it can be seen. The digitized representation 11 of the synthetic surface defect is an area having different gray values and contrasts. The corresponding surface defect is therefore designated synthetic, since the surface defect will not occur in this form in practice.

The photograph 10 resulting from a combination of the real photograph with the synthetic surface defect is fed to the image processing device 7, which, in the exemplary embodiment illustrated and to this extent preferred, is merged with a classification device 8. The image processing device 7 examines the photograph 10, including the digital representation 11 of the synthetic surface defect, for faults. If the digital representation 11 of the synthetic surface defect or a real surface defect is detected as a fault on the surface 4, this is classified by the classification device 8. In parallel, it is monitored whether the digital representation 11 of the synthetic surface defect is detected as a fault and classified correctly in accordance with the stipulations. In addition, a fault found because of the digital representation 11 of the synthetic surface defect, together with classification information and location information, is removed. This means that the fault information possibly found because of the digital representation 11 of the synthetic surface defect is removed and only the fault information that can be traced back to real faults as such is processed further. The fault information that can be traced back to the digital representations 11 of surface defects can if necessary be stored separately or processed further. It is thus ensured that the quality assurance of a product 5 is not affected by the checking of the inspection system 1.

If necessary, the digital representation 11 of a synthetic surface defect can not be classified or classified only to a restricted extent, since said surface defect does not resemble any real surface defect to be expected. Then, or else independently thereof, by using an integration unit, if necessary one or more digital representations 12 of surface defects which simulate and correspond to real surface defects can be integrated into photographs 10 of a surface of a product 5 that are produced by the camera 6. In the present case, these surface defects are a dent and a scratch. In this case, too, the resultant photograph 10 is examined for faults by the image processing device 7. If faults are found, these are classified by means of the integrated classification device 8. Since the digital representations 12 of surface defects correspond more or less to real surface defects, the quality of the classification can, if appropriate, be assessed better than in the case of the synthetic surface defects which are possibly examined in parallel.

Not illustrated in detail is the fact that the checking of the inspection system 1 is carried out at regular time intervals and, if necessary, automatic calibration of the inspection system 1 is triggered. In addition, by using the detected non-real faults and their classification, a performance index relating to quantifying the quality of the inspection system 1 is calculated and in addition a display is triggered as soon as specific predefined tolerance criteria are exceeded.

1.-15. (canceled)

16. A method for checking an inspection system that detects surface defects in products, the method comprising:
generating a photograph of a surface of a product;
transmitting the photograph in digitized form to an image processing device;
integrating a digitized representation of a surface defect into the digitized photograph;
performing fault detection in the image processing device by using the digitized photograph and the digitized representation; and
determining whether the image processing device detects the digitized representation of the surface defect as a fault of the surface of the product.

17. The method of claim 16 further comprising:
classifying the fault if detected by the image processing device with a classification device; and
determining whether the classification device correctly classifies the detected fault based on the digitized representation of the surface defect.

18. The method of claim 17 further comprising at least one of displaying, signaling, or storing the determinations of whether the surface defect was detected and whether the classification device correctly classified the detected fault.

19. The method of claim 17 further comprising determining at least one performance index characterizing a quality of the inspection system based on at least one of whether the image processing device detects the digitized representation of the surface defect as the fault or whether the classification device correctly classifies the detected fault.

20. The method of claim 17 further comprising at least one of the following:
calibrating the image processing device if the image processing device fails to detect the digitized representation of the surface defect; or
calibrating the classification device if the classification device incorrectly classifies the detected fault.

21. The method of claim 16 further comprising at least one of displaying, signaling, or storing information when the inspection system exceeds predefined tolerance criteria.

22. The method of claim 16 further comprising storing the fault based on the digitized representation of the surface defect, if stored at all, in a different manner than a manner in which a fault based on a real surface defect is stored.

23. The method of claim 16 further comprising storing the fault based on the digitized representation of the surface defect in a way so that the fault is automatically distinguishable from faults that are attributable to real surface defects.

24. The method of claim 16 further comprising storing faults attributable to real surface defects with at least one associated item of classification information.

25. The method of claim 16 further comprising storing faults attributable to real surface defects with at least one associated item of classification information, and storing in connection with the at least one associated item of classification information an item of location information that characterizes a location of each real surface defect in relation to an inspected surface.

26. The method of claim 16 wherein the digitized representation of the surface defect is a synthetically produced representation.

27. The method of claim 16 wherein the digitized representation of the surface defect is a representation of at least one of a real scratch, a real dent, a real elevation, a real surface crack, a real oxidation, a real containment, or a real foreign body.

28. An inspection system for detecting surface defects in products, the inspection system comprising:
a camera for producing a photograph of a surface of a product;
a digitization unit for digitizing the photograph;
an integration unit for integrating a digitized representation of a surface defect into the digitized photograph;
an image processing device for fault detection by using the digitized photograph and the digitized representation of the surface object; and
a determination unit for determining whether the digitized representation of the surface defect is detected by the image processing device as a fault of the surface of the product.

29. The inspection system of claim 28 further comprising a classification device for classifying the fault if detected by the image processing device, wherein the determination unit is configured to determine whether the classification device accurately classifies the fault based on the digitized representation of the surface defect.

30. The inspection system of claim 28 further comprising at least one of the following:
a display device for displaying information about whether the fault attributable to the digitized representation of the surface defect has been properly detected and/or accurately classified,
a signal device for signaling information about whether the fault attributable to the digitized representation of the surface defect has been properly detected and/or accurately classified, or
a storage device for storing information about whether the fault attributable to the digitized representation of the surface defect has been properly detected and/or accurately classified.
